(19) United States
(12) Patent Application Publication
(10) Pub. No.: US 2005/0255318 A1
(43) Pub. Date: Nov. 17, 2005

(54) Insulating component for insulating heat and/or sound, provided with a fire-retardant coating

(76) Inventor: Hans Czerny, Swisttal (DE)

Correspondence Address: WILLIAM COLLARD;COLLARD & ROE, P.C., 1077 NORTHERN BOULEVARD, ROSLYN, NY, 11576, US

(21) Appl. No.: 10/523,662

(22) PCT Filed: Jul. 23, 2003
(86) PCT No.: PCT/EP03/08030

§ 371 Date: Feb. 4, 2005

(30) Foreign Application Priority Data
Aug. 23, 2002 (DE) 10239631.0

(51) Int. Cl. B32B 27/00

(52) U.S. Cl. 428/402; 442/136; 428/304.4

(57) ABSTRACT

The present invention relates to an insulation component for thermal and/or sound insulation, particularly for motor vehicles, which is at least partially provided with a fire-retardant coating (3). To achieve a high refractoriness, a good insulation effect, and favorable manufacturing costs, a fire-retardant coating (3) is suggested for the insulation component which is composed of at least the following components:

| | |
|---|---|
| 40 to 90 wt. % | of a ceramic adhesive, |
| 5 to 50 wt. % | ceramic micro hollow |
| | spheres having a grain size |
| | in the range from 0.1 to |
| | 3 mm |
| 0.1 to 10 wt. % | of a propellant which |
| | expands under the effect of |
| | heat. |

The present invention relates to an insulation component for thermal and/or sound insulation, particularly for motor vehicles, which is at least partially provided with a fire retardant coating.

Equipping sound and thermal insulation elements for motor vehicles, which are manufactured from foam, with fire retardants, particularly to prevent unnecessary fire propagation in the event of an accident of the motor vehicle resulting in fire, is known. Thus, for example, a sound-absorbing dashboard lining to be positioned between the engine compartment and the passenger compartment of a motor vehicle, which has a porous layer made of felt or polyurethane foam facing toward the engine compartment, is described in DE 199 18 269 A 1, and where applying a fire-retardant coating, particularly a fire retardant having a copolymer made of vinylidene fluoride and hexafluoropropene, to the porous layer in order to produce a fire protection in relation to the engine compartment being suggested.

A sound and thermal insulation agent for insulating buildings, vehicles, conduits, and the like, which comprises a core layer made of fibers or similar materials that are provided with a fire-retardant additive, is known from DE 199 05 226 A1, the core layer being coated on at least one external surface with a reactivatable material that is nonflammable or poorly flammable and foams at a predefined temperature. The fire retardant additive is nitrogen or borax. DE 199 05 226 A1 provides no further details in regard to the composition of the poorly-flammable foaming material.

DE 197 25 761 A1 describes a method for manufacturing a fire-retardant fire protection coating mass for metallic and mineral substrates. The coating mass essentially consists of a water glass solution, a thixotropic agent (e.g., bentonite), mica, magnesium silicate, kaolin, wollastonite, water, and fine-pored round granules made of glass and/or hollow glass spheres, the round granules and the hollow glass spheres having a grain size from 0.2 to 4.0 mm.

Furthermore, a coating composition for fire protection and sound protection purposes, which essentially comprises 25 to 60 wt. % (weight-percent) of a light aggregate, 20 to 60 wt. % binder, less than 50 wt. % absorption agent, 5 to 30 wt. % expander, and 2 to 20 wt. % of a carbonized acoustic fiber, as well as the selective use of one or more surfactants, thickeners, agents for increasing the strength, retardants, and antibacterial agents, is known from DE 199 22 247 A1.

The present invention is based on the object of providing an insulation component of the type cited at the beginning, which has a high refractoriness and good insulation effect as well as favorable manufacturing costs in relation to conventional insulation components.

This object is achieved according to the present invention by the insulation component having the features of Claim 1. Preferred and advantageous embodiments of the present invention are specified in the subclaims.

The insulation component according to the present invention is thus at least partially provided with a fire-retardant coating, which is composed from at least the following components:
40 to 90 weight-percent of a ceramic adhesive,
5 to 50 weight-percent ceramic micro hollow spheres having a grain size in the range from 0.1 to 3.0 mm, and
0.1 to 10 weight-percent of a propellant (propellant) which expands under the effect of heat.

The insulation component according to the present invention is distinguished by especially high thermal resistance with high thermal and acoustic insulation effect. These properties may be realized with relatively favorable manufacturing costs.

According to an advantageous embodiment, the fire-retardant coating of the insulation component according to the present invention may have 0.1 to 5 weight-percent aluminum powder having a grain size less than or equal to 50 μm, and/or 0.1 to 20 weight-percent aluminum hydroxide as further components. The fire-retardant coating obtains a favorable reflectivity through the aluminization. A higher proportion of the thermal radiation incident on the coating surface is thus reflected, because of which the thermal strain of the insulation component is correspondingly reduced. Aluminum hydroxide has a fire extinguishing function, so that its addition as an additive is also advantageous.

In another advantageous embodiment of the insulation component according to the present invention, the fire-retardant coating has 5 to 30 weight-percent thermoplastic powder adhesive as a further component. For this purpose, thermoplastic fine powder adhesives made of CO-polyethylene terephthalate (CO-PET), co-polyamide (CO-PA), or TPO particularly come into consideration. In addition to the adhesive ability upon thermal treatment, the thermoplastic powder adhesive also causes the fire-retardant coating to be more flexible.

Especially high refractoriness may be achieved if a fireproof ceramic adhesive based on a water glass solution, which preferably has a temperature resistance of greater than 1000° C., is used as the ceramic adhesive in the fire-retardant coating.

The ceramic micro hollow spheres used as a filler cause a significant reduction of the density and therefore the weight of the fire-retardant coating. In addition, the ceramic micro hollow spheres improve both the thermal and the acoustic insulation effect of the insulation component according to the present invention through their gas inclusions. Furthermore, the ceramic micro hollow spheres reduce the need for ceramic adhesive, improve the mechanical properties of the insulation component, such as the abrasion resistance, are not combustible, are chemically inert, and have a high temperature resistance. The ceramic micro hollow spheres may preferably comprise 55 to 68 weight-percent SiO₂, 25 to 36 weight-percent Al₂O₃, and 0 to 6 weight-percent Fe₂O₃. Micro hollow spheres of this type have a temperature resistance of greater than 1000° C.; they may particularly be temperature resistant up to 1200° C.

The propellant used in the fire-retardant coating of the insulation component is preferably made of hollow polymer plastic particles, which have a gas-tight covering that is insoluble in water, in which liquid and/or gaseous hydrocarbon is encapsulated. The polymer plastic particles preferably have a grain size in the range from 2 to 50 μm. The polymer plastic of the gas-tight covering and the hydrocarbon encapsulated therein are preferably selected so that the hollow polymer plastic particles begin to expand under the effect of heat from a temperature of greater than 100° C. and burst from a temperature of greater than 130° C., the encapsulated hydrocarbon being released as propellant gas.

In the following, the invention will be explained in greater detail on the basis of a drawing illustrating multiple exemplary embodiments.

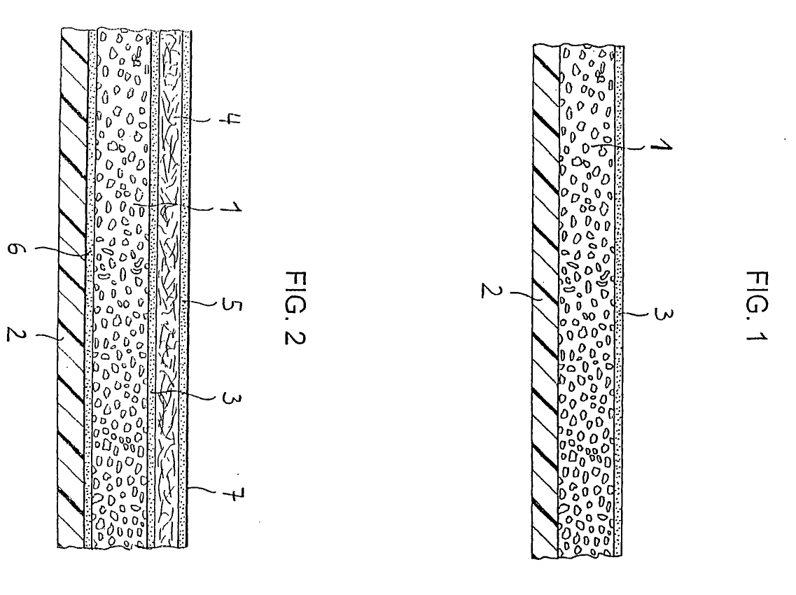

FIG. 1 shows a schematic sectional illustration of a section of an insulation component according to the present invention according to a first exemplary embodiment and

FIG. 2 shows a schematic sectional illustration of a section of an insulation component according to the present invention according to a second exemplary embodiment.

FIG. 1 shows a section of an insulation component for thermal and sound insulation in a motor vehicle. The insulation component is constructed from a foam layer 1 and a heavy layer 2. The foam layer 1 and the heavy layer 2 form an acoustic spring-mass system. The heavy layer 2 may be applied to the back of the foam layer 1 through rear injection molding, for example. The foam layer preferably consists of open-pored melamine resin foam. The heavy layer may comprise, for example, thermoplastic material which contains additives and is denser than the porous foam layer 1. In particualr, the heavy layer 2 may comprise an artificial resin which has a high proportion of inorganic fillers having a high molecular weight, or a mixture of polyolefins or polymer EPDM.

The foam layer 1 is provided with a fire-retardant coating 3, which represents an expandable, ceramic adhesive system. In the event of exposure to flame or corresponding thermal influence, the fire-retardant coating 3 expands and prevents the propagation of sources of fire and/or temperature penetrations. Glass and/or mineral fibers, in the form of a reticulate fiberglass scrim, for example, may be embedded in the fire-retardant coating 3 to increase its mechanical strength.

The exemplary embodiment shown in FIG. 2 differs from the exemplary embodiment in FIG. 1 primarily in that a further layer 4 made of nonwoven material is positioned above the foam layer 1. The nonwoven material may, for example, comprise fiberglass and/or mineral fibers. The nonwoven material layer 4 is provided on the outside with a fire-retardant coating 5, which essentially corresponds to that of the insulation component shown in FIG. 1. A further difference of the exemplary embodiment in FIG. 2 is that the heavy layer 2, the foam layer 1, and the nonwoven material layer 4 are glued to one another by intermediate coatings 5, 6 of the fire-retardant coating material.

Furthermore, the insulation component may be provided on its outside with an aluminum film 7, the aluminum film 7 being positioned exposed and being glued by the fire-retardant coating 5 to the layer 4 made of nonwoven material or foam, for example, lying underneath.

In the following, examples of compositions of the fire-retardant coating 3, 5, and/or 6 will be specified:

### EXAMPLE 1

| | |
|---|---|
| 40 to 90 wt. % | ceramic adhesive |
| 5 to 50 wt. % | ceramic micro hollow spheres |
| | having a grain size in the range |
| | from 0.1 to 3 mm |
| 0.1 to 10 wt. % | propellant which is expandable |
| | under the effect of heat |

### EXAMPLE 2

| | |
|---|---|
| 40 to 90 wt. % | ceramic adhesive |
| 5 to 50 wt. % | ceramic micro hollow spheres |
| | having a grain size in the range |
| | from 0.1 to 3 mm |
| 0.1 to 10 wt. % | propellant which is expandable |
| | under the effect of heat |
| 0.1 to 5 wt. % | fine aluminum powder having a |
| | grain size less than or equal to |
| | 50 μm |
| 0.1 to 20 wt. % | aluminum hydroxide (Al₂O₃ × H₂O) |

### EXAMPLE 3

| | |
|---|---|
| 40 to 90 wt. % | ceramic adhesive |
| 5 to 50 wt. % | ceramic micro hollow spheres |
| | having a grain size in the range |
| | from 0.1 to 3 mm |
| 0.1 to 10 wt. % | propellant which is expandable |
| | under the effect of heat |
| 5 to 30 wt. % | fine thermoplastic powder |

The ceramic adhesive is a fireproof adhesive based on water glass solutions (suspensions). It forms the basic matrix of the fire-retardant coating 3, 5, and/or 6 and has a temperature resistance of greater than 1000° C., for example, 1050° C.

The ceramic adhesive typically has the following chemical composition:
34 to 35 wt. % SiO₂
0.01 to 0.04 wt. % MgO
6 to 7 wt. % Na₂O
8 to 9 wt. % Al₂O₃
0.01 to 0.04 wt. % CaO
48 to 51 wt. % H₂O
0.1 to 0.4 wt. % Fe₂O₃
0.1 to 0.4 wt. % K₂O

The ceramic micro hollow spheres represent a lightweight filler. They reduce the need for ceramic adhesive, and are non-combustible, chemically inert, and temperature resistant up to a temperature range from approximately 1100 to 1200° C. They reduce the density of the fire-retardant coating 3, 5, 6 and elevate its thermal and acoustic insulation effect. They have a coefficient of thermal conductivity of approximately 0.09 Wm⁻¹K⁻¹. Their piled weight is in the range from 200 to 600 g/l. In addition, they improve the mechanical properties of the insulation component, particularly its abrasion resistance, as well as its dimensional stability.

The propellant contained in the fire-retardant coating 3, 5, 6 preferably consists of small, hollow plastic particles which have a gas-tight covering, insoluble in water, made of a mixed polymer in which liquid and/or gaseous hydrocarbon is encapsulated. The hollow plastic particles have a grain diameter in the range from approximately 2 to 50 μm, preferably in the range from approximately 10 to 20 μm. If the hollow plastic particles are heated by the effect of heat and/or fire, the liquid hydrocarbon enters the gas phase. The pressure of the gaseous hydrocarbon increases with rising temperature. The gas-tight covering simultaneously softens, so that the volume of the hollow plastic particles increases manyfold. The volume increase may, for example, be 30 to 50 times the original volume. The material of the gas-tight covering and the hydrocarbon enclosed therein are selected so that the volume increase (expansion) is triggered in the event of thermal influence from a specific temperature range. The triggering temperature is preferably at a temperature of greater than 1000° C.

In a specific temperature range, the covering is so soft that in the event of further temperature increase, it finally bursts and releases the encapsulated hydrocarbon as the propellant gas. The temperature range in which the propellant gas is released is above approximately 130° C.

The aluminum powder optionally contained in the fire-retardant coating 3, 5, 6 causes a thermal radiation reflection at the exposed coating surface. In addition, it may be used to visually delimit the fire-retardant coating 3, 5, 6, in that it makes it clearly visible. The aluminum powder used has a grain size of less than or equal to 50 μm, preferably less than or equal to 20 μm.

The aluminum powder may contain aluminum hydroxide (Al₂O₃×H₂O) as an additive. Aluminum hydroxide has a fire-extinguishing effect.

Furthermore, the fire-retardant coating 3, 5, 6 may contain a thermoplastic adhesive, activatable by heat, in the form of fine thermoplastic powder. The thermoplastic adhesive may comprise, for example, CO-polyethylene terephthalate (CO-PET), co-polyamide (CO-PA), and/or TPO. The thermoplastic adhesive makes the fire-retardant coating 3, 5, 6 more flexible and gives the coating 3, 5, 6 adhesive properties upon thermal treatment. In this way, the fire-retardant coating 3, 5, 6 may be bonded especially well to foam layers and textile materials.

The composition made of the above-mentioned components may be applied to the particular layer of the insulation component as an aqueous suspension through spraying, spread coating, rolling, or painting. The ceramic, fire-retardant coating thus produced has excellent adhesive properties and an exceptional barrier effect against thermal strain and direct exposure to flame. It is flexible, may be processed well, and may be manufactured cost-effectively.

An insulation component thus equipped may particularly be used as an acoustic dashboard insulation and as an acoustically effective heat protection shield in motor vehicles.

1-14. (canceled)

15. An insulation component for thermal and/or sound insulation, particularly for motor vehicles, which is at least partially provided with a fire-retardant coating (3, 5, 6), wherein the fire-retardant coating (3, 5, 6) is composed of at least the following components:

| | |
|---|---|
| 40 to 90 wt. % | of a ceramic adhesive, |
| 5 to 50 wt. % | ceramic micro hollow spheres having a |
| | grain size in the range from 0.1 to |
| | 3 mm, |
| 5 to 30 wt. % | thermoplastic powder adhesive, and |
| 0.1 to 10 wt. % | of a propellant which expands under the |
| | effect of heat, which is made of hollow polymer plastic |
| | particles, having a gas-tight covering that is insoluble in |
| | water, in which liquid and/or gaseous hydrocarbon is |
| | encapsulated, the thermoplastic powder adhesive |
| | being made of CO-polyethylene terephthalate |
| | (CO-PET), co-polyamide (CO-PA), and/or |
| | thermoplastic elastomer based on olefins (TPO). |

16. The insulation component according to claim 15, wherein the fire-retardant coating (3, 5, 6) contains, as further components,

| | |
|---|---|
| 0.1 to 5 wt. % | aluminum powder having a grain size less |
| | than or equal to 50 μm, and/or |
| 0.1 to 20 wt. % | aluminum hydroxide. |

17. The insulation component according to claim 15, wherein the ceramic adhesive is a fireproof ceramic adhesive based on a water glass solution.

18. The insulation component according to claim 15, wherein the ceramic adhesive has a temperature resistance of greater than 1000° C.

19. The insulation component according to claim 15, wherein the ceramic micro hollow spheres have the following composition:
55 to 68 wt. % SiO₂,
25 to 36 wt. % Al₂O₃, and
0 to 6 wt. % Fe₂O₃.

20. The insulation component according to claim 15, wherein the ceramic micro hollow spheres have temperature resistance of greater than 1000° C.

21. The insulation component according to claim 15, wherein the hollow polymer plastic particles expand under the effect of heat from a temperature greater than 100° C.

22. The insulation component according to claim 15, wherein the hollow polymer plastic particles burst under the effect of heat at a temperature greater than 130° C., the liquid and/or gaseous hydrocarbon being released as a propellant gas.

23. The insulation component according to claim 15, wherein the hollow polymer plastic particles have a grain size in the range from 2 to 50 μm.

24. The insulation component according to claim 15, wherein the insulation component is made of multiple layers (1, 2, 4) of nonwoven material, foam, and/or heavy layer material, at least two of the layers (1, 2, 4) being glued to one another by the fire-retardant coating (3, 5, 6).

25. The insulation component according to claim 15, wherein the insulation component is provided on the outside with the fire-retardant coating (5) and an aluminum film (7), the aluminum film (7) being positioned exposed and being glued to a further layer (4) of the insulation component by the fire-retardant coating (5).
